(19) United States
(12) Patent Application Publication
(10) Pub. No.: US 2025/0165966 A1
(43) Pub. Date: May 22, 2025

(54) TOKENIZED DEPOSIT WITH CHOICE FOR DEPOSITOR

(71) Applicant: Wells Fargo Bank, N.A., San Francisco, CA (US)

(72) Inventors: Nathaniel C. Eutsler, San Francisco, CA (US); Matthew Mullin Shepherd, Charlotte, NC (US)

(73) Assignee: Wells Fargo Bank, N.A., San Francisco, CA (US)

(21) Appl. No.: 18/510,898

(22) Filed: Nov. 16, 2023

(51) Int. Cl. G06Q 20/38; G06Q 20/10; G06Q 40/03

(52) U.S. Cl. CPC G06Q 20/389; G06Q 20/108; G06Q 20/3829; G06Q 40/03

(57) ABSTRACT

Some arrangements relate to a system comprising a memory and one or more processors configured to receive from a first computing system of a depositor over a network, a deposit request corresponding to a first funds. In response to receiving a deposit request, first tokens are generated by tokenizing the first funds. To generate first tokens, a private key is used to create the first tokens, a public key of depositor is used to associate the depositor to the first tokens. The depositor is identified by the public and the first tokens are minted using the private key by executing one or more smart contracts.

### TECHNICAL FIELD

The present implementations relate generally to digital assets, and more particularly to allocation and uses of digital assets.

### INTRODUCTION

The present disclosure relates generally to assets, and more particularly to a determined use for digital assets. In a computer networked environment such as the internet, users and entities, such as people, organizations, or companies, may exchange digital assets.

### SUMMARY

Some arrangements relate to a system including a memory and one or more processors configured to receive from a first computing system of a depositor over a network, a deposit request corresponding to a first funds. In response to receiving a deposit request, generate first tokens by tokenizing the first funds. To generate first tokens, the one or more processors can use a private key to create the first tokens, use a public key of depositor to associate the depositor to the first tokens, the depositor is identified by the public and mint the first tokens by using the private key by executing one or more smart contracts. Tokenizing the first funds includes generating a metadata object including metadata of the first funds, the metadata indicating the at least one of the type or the condition of the tokenized products to which the first token is applied and linking the metadata object to the first token. In response to determining a tokenized product, receive a loan request corresponding to a downpayment loan or collateral. In response to receiving the loan request, generate a loan token by tokenizing the downpayment loan or collateral and transmit the loan token to a digital wallet. The one or more processors can generate interest on the tokenized product based on the loan token, generate a new loan token based on the interest on the tokenized product and the loan token, burn the loan token, and store the new loan token.

The one or more processors can further receive, from the first computing system, a message indicating at least one of a type or a condition of tokenized products to which the first token is applied and generate one or more smart contracts for applying the first tokens to the at least one of the type or the condition of the tokenized product. The type includes identification for a group of products or services corresponding the providing funds or tokens to a user. The one or more processors can further select from the first computing system of the depositor over the network, an intended customer segment. Furthermore, the one or more processors can receive, by the first computing system, a determination by the depositor to specify the use of the first tokens. The one or more processors can further embed the intended customer segment as a condition in the first tokens, wherein the first token has an object field for the intended customer segment. The one or more processors can further identify a tokenized product of a user with the type of the tokenized products, the tokenized product includes at least one attribute that fulfills the condition and execute the one or more smart contracts to apply the first tokens to the tokenized product of the user. The one or more processors can further execute a first contract when a borrow matches the intended customer segment. the borrow is linked to a borrow metadata object, the borrow metadata object includes a borrower corresponding to a second digital wallet and the intended customer segment.

Some arrangements relate to a system including a memory and one or more processors configured to receive, from a first computing system, a loan request corresponding to first funds and a rule, in response to receiving the loan request, generate first tokens by tokenizing the first funds and generate a rule token by tokenizing the rule. The one or more processors can generate a funds metadata object including metadata of the first funds, generate, based on the funds metadata object, the first tokens including a link to the funds metadata object. The one or more processors cam generate a rule metadata object including metadata of the rule and generate, based on the rule metadata object, the rule token including a link to the rule metadata object. The one or more processors can verify, by a digital signature of a user device, the rule between an owner the first digital wallet and an owner of the second digital wallet. The one or more processors can transmit the rule token to a second digital wallet associated with the first computing system and transmit the first tokens to a first digital wallet and detect, an indication by a matching mechanism for the owner of the second digital wallet. The matching mechanism can determine, by the first computing system, a location of the owner of the first digital wallet, determine that the location is within an area corresponding to a condition embedded in the first tokens and generate, by the first computing system, the indication based on the area corresponding to the condition. The one or more processors can further convert the first tokens into fiat funds and transfer the fiat funds into a funds account associated with the one or more processors, receive a loan request corresponding to a downpayment loan or collateral, in response to receiving the loan request, generate a loan token by tokenizing the downpayment loan or collateral and transfer the loan token to the first digital wallet.

Some arrangements relate to a method executable by a data processing system including receiving, by the one or more processors from a first computing system of a depositor over a network, a deposit request corresponding to a first funds, in response to receiving a deposit request, generating, by the one or more processors, first tokens by tokenizing the first funds. The method to tokenize the first funds includes generating, by the one or more processors, a metadata object including metadata of the first funds, the metadata indicating the at least one of the type or the condition of the tokenized products to which the first token is applied, generating, by the one or more processors, the first token by embedding the metadata object to the first token. The method includes receiving, by the one or more processors from the first computing system, a message indicating at least one of a type or a condition of tokenized products to which the first token is applied, generating, by the one or more processors, one or more smart contracts for applying the first tokens to the at least one of the type or the condition of the tokenized product, identifying, by the one or more processors, a tokenized product of a user with the type of the tokenized products, the tokenized product includes at least one attribute that fulfills the condition and executing, by the one or more processors the one or more smart contracts to apply the first tokens to the tokenized product of the user. The method further includes in response to determining a tokenized product, receiving, by the one or more processors, a service request corresponding to a downpayment loan or collateral in response to receiving the service request, generating, by the one or more processors, a loan token by tokenizing the downpayment loan or collateral and transmitting, by the one or more processors, the loan token to a digital wallet.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 depicts an example system, in accordance with present implementations.

FIG. 2 depicts an example digital asset architecture, in accordance with present implementations.

FIG. 3 depicts an example digital asset architecture, in accordance with present implementations.

FIG. 4 depicts an example transaction processor, in accordance with present implementations.

FIG. 5 depicts a method to facilitate asset deposits utilizing tokens, in accordance with present implementations.

FIG. 6 depicts a method to facilitate loan exchanges utilizing tokens, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

This technical solution can include a smart contract control structure that encapsulates a token. The smart contract control structure can allow output of various contents linked to the token upon determining at least one attribute (e.g., transferring attribute, outputting attribute, etc.) of a plurality of attributes is satisfied. For example, the smart contract control structure, and the token within the smart contract control structure, can be rendered unusable outside the particular computing environment. This technical solution can include multiple layers of secure access control to tokens, including authorization control at a smart contract layer by one or more tokens, and authorization control at a container layer by a private key. The private key can be based on one or more tokens and can be fully contained within a single token or partially contained within multiple tokens. This technical solution can include generation of smart contract control structures and modification of blockchain architecture to restrict the tokens. A smart contract can, for example, generate or modify a smart contract to contain one or more tokens. The generator smart contract can search a blockchain to identify tokens satisfying particular attributes or parameters. The attributes can be transmitted to the generated smart contract by a token. The generated smart contract can generate a token that can include a non-fungible token (NFT), a semi-fungible token, or a fungible token, and can distribute that token while retaining locally the smart contract control structure and its restricted tokens.

The systems described herein provide improvements over typical asset exchange systems and data storage/access system. That is, the technical problem arises from typical asset exchange systems when assets and the data of assets are stored without knowledge of where the assets are transmitted and how they are used. Thus, to improve asset awareness, a technical solution is accomplished by restricting the assets (e.g., digital or virtual) utilizing a token that is limited by the choice of a depositor. This not only restricts the use of the asset by a financial institution but allows the depositor to dictate to whom and where the assets are going, which is a novel concept to give control to the depositor of the assets. Furthermore, the system described herein may provide an improvement over typical asset exchange systems and data storage/access system through the process of tokenizing funds. The tokenized fund may provide the advantage of being able to transfer funds, more particularly representation of funds (e.g., the tokens, etc.), in short amounts of time, or real-time, removing the need of long processing time associated with transfer of funds between funds accounts (e.g., cash accounts, etc.).

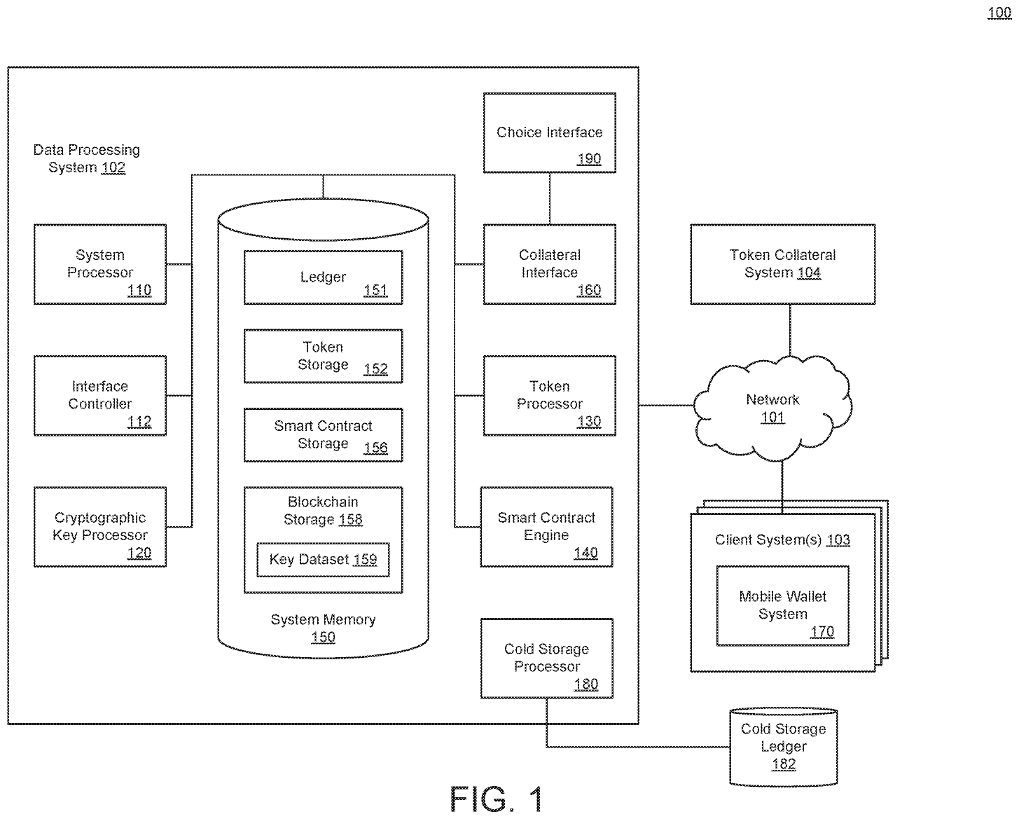

FIG. 1 depicts an example system. As illustrated by way of example of FIG. 1, the example system can include at least a network 101, a data processing system 102, a client system 103, and a token collateral system 104.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include a network which is virtual and sits on top of one or more layers of other networks 101. The network 101 can include any such network topology as known to those ordinarily skilled in the art capable of supporting the operations described herein. The network 101 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 101 can include a type of a broadcast network, a telecommunications network, a data communication network, or a computer network.

The data processing system 102 can include a physical computer system operatively coupled or that can be coupled with one or more components of the system 100, either directly or through an intermediate computing device or system. The data processing system 102 can include a virtual computing system, an operating system, and a communication bus to effect communication and processing. The data processing system 102 can include a system processor 110, an interface controller 112, a cryptographic key processor 120, a token processor 130, a smart contract engine 140, a system memory 150, a collateral interface 150, a cold storage processor 180, and a choice interface 190.

The system processor 110 can execute one or more instructions associated with the system 100. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the system 100 generally can include one or more communication bus controller to effect communication between the system processor 110 and the other elements of the system 100.

The interface controller 112 can link the data processing system 102 with one or more of the networks 101, the client system 103, and the token collateral system 104, by one or more communication interfaces. A communication interface can include, for example, an application programming interface (“API”) compatible with a particular component of the data processing system 102, the client system 103, or the token collateral system 104. The communication interface can provide a particular communication protocol compatible with a particular component of the data processing system 102 and a particular component of the client system 103 or the token collateral system 104. The interface controller 112 can be compatible with particular metadata objects and can be compatible with particular metadata delivery systems corresponding to particular metadata objects. For example, the interface controller 112 can be compatible with transmission of video content, audio content, or any combination thereof. For example, the interface controller 112 can be compatible with payment processing transmissions by a protocol compatible with payment processing latency and encryption structures.

The interface controller 112 can establish a data channel between a source address and a destination address, such that receivals or transmissions of a token occurs between the addresses on a ledger (e.g., the blockchain storage 158) and/or a digital wallet (e.g., the client system 103). An address can be generated based on executing, by the cryptographic key processor 120, a math-based function (e.g., hash, symmetric encryption, asymmetric encryption) on a public key of a public and private key pair (or a verification key of a verification and signing key pair). For example, if the interface controller 112 receives a token from any system or device described herein, the token or other data received may include metadata associated with a source address, and the interface controller 112 may determine a destination address (e.g., may be provided to the system sending the token in advance) to store the token in the blockchain storage 158. In various arrangements, the addresses may be a unique sequence of randomized (or pseudo-randomized) numerical digits, characters, punctuation, whitespace, code (e.g., QR), or symbols.

The cryptographic key processor 120 can generate and modify cryptographic keys. For example, the cryptographic key processor 120 can include one or more asymmetric or symmetric key generators and can generate public-private key pairs. For example, a public-private key pair can include a public key configured to encrypt in accordance with a particular transform process. For example, a public-private key pair can include a private key configured to decrypt in accordance with a particular transform process compatible with the public key. In some arrangements, the cryptographic key processor 120 can link the public-private key pair with any individual object or component. In some arrangements, the cryptographic key processor 120 can link any public key or private key corresponding to the public-private key pair with any individual object or component. For example, the cryptographic key processor 120 can generate a key compatible with or linked with a particular identifier corresponding to a particular, device, user, customer, account, system, or any combination thereof.

Upon receiving a token, the cryptographic key processor 120 can identify public keys and private keys associated with the token. Upon identifying one or more private keys of the token, the cryptographic key processor 120 can verify the token using the one or more identified private keys. In some embodiments, the token may have been previously stored on the data processing system 102 and the public-private key pairs may be stored throughout the data processing system 102 (e.g., in the blockchain storage 158, a cold storage ledger 182, etc.). In some arrangements, the received token may be an external token stored on a storage medium or a cache remote from the data processing system 102 (e.g., a digital wallet, a crypto-wallet, other storage mediums or caches, etc.), such as on the client system 103 or the token collateral system 104.

In some embodiments, the cryptographic key processor 120 can sign the token using a private key and verify the token using a public key. For example, signing the token can include encrypting the token using a specific private key to create a digital signature (e.g., biometric scan, fingerprint capture, passcode verification, etc.) and verifying the token can include decrypting the token using a specific public key to verify the digital signature of the specific private key, or an address of the specific private key. The address of the specific private can be a hashed version of the specific private key based on a hash function (e.g., hash table, hash map). The public and private key may be symmetric (e.g., use the same key to sign/verify) or asymmetric (e.g., use different keys to sign/verify). For example, each key of the public-private key pair may identical. In some arrangements, an algorithm (e.g., a hash algorithm, etc.) can be applied to a private key to generate a public key.

Generating private and public keys can include concatenating multiple public-private key pairs into a single public-private key pair based on merging, using a math-based function, multiple key pairs. For example, a wallet public key or wallet public-private key pair can be provided by the mobile wallet system 170 with a token (e.g., for deposit). The cryptographic key processor 120 can generate a new internal public-private key pair prior to storing the token. The math-based function can be, but is not limited to, a Rivest-Shamir-Adleman, elliptic curve cryptography, Digital Signature Algorithm, asymmetric algorithm, hash algorithm or function, or symmetric algorithm, and so on. For example, executing the math-based function can include generating (or aggregating) a concatenated public key based on executing a concatenation of the wallet public key and the additional public key and hashing, utilizing salting, the concatenated public key based on a hash function, where salting includes providing random data and the concatenated public key as input to the hash function. In particular, the “salt” can be random data such as random bits that is used as an additional input to a one-way function such as a hashes or encryption algorithm. A new salt can be randomly generated by the cryptographic key processor 120 each time salting occurs. Salting can occur based on a preference of a user depositing the token or in response to analyzing metadata of the token (e.g., based on value of the token or data stored in a metadata object).

In some embodiments, the cryptographic key processor 120 can also be configured to generate public and private key pairs and the interface controller 112 can be configured to provide public keys (or public and private key pairs, or private keys) to one or more computing devices (e.g., the client system 103, the token collateral system 104, etc.) for use in a token collateral request. The interface controller 112 can interface (e.g., using an API) with one or more other ledger systems (other blockchain ledgers) and wallets (e.g., digital, crypto, etc.). In various embodiments, the public and private key pair can be generated based on a cryptographic function (e.g., symmetric-key algorithms (Data Encryption standard (DES), Advanced Encryption Standard (AES), etc.), asymmetric-key algorithms (Ed25519 signing, Elliptic Curve Cryptography (ECC), etc.), public-key algorithms (Rivest-Shamir-Adleman (RSA), etc.), etc.) and be stored in the data processing system 102. In various embodiments, the keys of the public and private key pairs may be stored in separate locations. For example, public keys may be stored in the key dataset 159 and the private keys may be stored in a cold storage ledger 182. In some embodiments, the public and private key pairs may be stored together (as one data package) in the key dataset 159. In some embodiments, the data processing system 102 can maintain (e.g., store and access keys) the key dataset 159 such that each token may be locked-unlocked and associated with a public key or public-private key pair stored on the key dataset 159. In various arrangements, public-private key pairs can be shared amongst a plurality of tokens or can be unique to each token on the blockchain storage 158.

The token processor 130 may identify one or more characteristics of tokens. For example, the token processor 130 may identify one or more characteristics of an individual token or a plurality of tokens satisfying criteria. The criteria by which tokens can be identified can include aspects of the token, fields, or components of the token, transform processes used to generate or modify the token, aspects of a metadata object linked with the token, or any combination thereof. For example, aspects of the token can include a hash of the token, or a value of an individual field of the token. The token processor 130 can generate a trait corresponding to one or more characteristics of a token or an object linked with the token. For example, the trait can include a scalar or vector quantity corresponding to one or more values of an aspect of the token. The trait can include a numeric value corresponding to an identifier of the token. In some embodiments, the token may be a fungible or a NFT.

The smart contract engine 140 (e.g., smart contract processing circuit, etc.) can generate and modify one or more smart contracts. The smart contract engine 140 can execute instructions to generate or modify a cryptographic container, to add or remove objects from a cryptographic container, and to execute various processors linked with or embedded with a smart contract. For example, the smart contract engine 140 can execute various processors of a smart contract in response to detecting input including or corresponding to a particular token at the smart contract. In another example, the smart contract engine 140 can include processors to read, write, generate or modify one or more objects contained within a container of the smart contract, one or more tokens input to the smart contract, or one or more processors of the smart contract. Furthermore, the smart contract engine 140 can obtain one or more tokens from the token processor 130, against one or more smart contracts. For example, the smart contract engine 140 can obtain one or more tokens from the token processor 130 to compare the one or more tokens against a particular one or more tokens requested by one of the one or more smart contracts.

The smart contract engine 140 can enforce the terms of collateral, transmitted by the collateral interface 150, by a particular smart contract. For example, the smart contract engine 140 can obtain the one or more tokens, corresponding to collateral, and can analyze and parse the token to determine the terms of the collateral. The particular smart contract can enforce the terms of the collateral. The smart contract engine 140 can detect whether a particular token is compatible with a particular smart contract by detecting whether the particular token matches a particular token characteristic associated with the particular smart contract. For example, the smart contract engine 140 can detect that a token is compatible with a smart contract based on comparing a hash of the token with a hash included in the smart contract.

The collateral interface 150 can communicate with an external system compatible with transferring a token. For example, the collateral interface 150 can include an application programming interface (API) compatible with the token collateral system 104 and the client system 103. In another example, the collateral interface 150 can receive characteristics associated with particular tokens, types of tokens, or metadata objects linked with particular tokens. In another example, the collateral interface 150 can communicate with the choice interface 190 to provide the technical improvement of determining where and how the tokens can be used. The communication interface 150 can be configured to receive a collateral request from a user device or an external system. For example, the collateral interface 150 can receive, from the user device, a request to use the assets of another depositor, defined by the choice interface 190.

The choice interface 190 can determine how the tokens can be used by a financial institution. Furthermore, the choice interface 190 can communicate with a user device or an external system compatible with transferring a token. For example, the choice interface 190 can specify that the financial institution can use the tokens toward a particular type of business (e.g., small business, corporation, nonprofit organization, privately held, etc.). In another example, the choice interface 190 can communicate with the collateral interface 150 to specify a particular type of user who can access the tokens of the depositor. In another example, the choice interface 190 can specify a specific geographical region (e.g., North America, the United States, Massachusetts, Boston, South end of Boston, etc.) where the financial institution can use the tokens.

The system memory 150 can store data associated with the system 100. The system memory 150 can include one or more hardware memory devices to store binary data, digital data, or the like. The system memory 150 can include one or more electrical components, electronic components, programmable electronic components, reprogrammable electronic components, integrated circuits, semiconductor devices, flip flops, arithmetic units, or the like. The system memory 150 can include at least one of a non-volatile memory device, a solid-state memory device, a flash memory device, and a NAND memory device. The system memory 150 can include one or more addressable memory regions disposed on one or more physical memory arrays. A physical memory array can include a NAND gate array disposed on, for example, at least one of a particular semiconductor device, integrated circuit device, or printed circuit board device. The system memory 150 can include a ledger 151, a token storage 152, a smart contract storage 156, and a blockchain storage 158 including a key dataset 159.

The token storage 152 can store one or more tokens and corresponding addresses for particular tokens that indicate links with the corresponding tokens. The token storage 152 can include tokens associated with the data processing system 102 or any component thereof, the client system 103 or any component thereof, any metadata object, or any combination thereof. In some arrangements, the token storage 152 can store one or more fungible tokens, semi-fungible tokens, and/or NFT. The token storage 152 can store corresponding addresses for particular fungible tokens that indicate links with the corresponding fungible tokens, corresponding addresses for particular semi-fungible tokens that indicate links with the corresponding semi-fungible tokens, and/or corresponding addresses for particular NFT that indicate links with the corresponding NFT.

The smart contract storage 156 can store one or more smart contracts and corresponding addresses for particular smart contracts that indicate links with the corresponding smart contracts. The smart contract storage 156 can also store one or more control structures and their contained metadata objects and corresponding addresses for particular control structures that indicate links with the corresponding control structures.

The blockchain storage 158 can store one or more blockchains linked to one or more smart contracts, tokens, control structures, or metadata objects, by corresponding addresses for particular smart contracts, tokens, control structures, or metadata objects that indicate links with a particular blockchain.

The key dataset 159 can store cryptographic keys associated with the data processing system 102 or any component thereof, the client system 103 or any component thereof, any metadata object, or any combination thereof. For example, the key dataset 159 can include public-private key pairs or private keys corresponding to particular accounts, tokens, smart contracts, devices, users, systems, or any combination thereof.

The client system 103 can include a computing system located remotely from the data processing system 102. The client system 103 can include a mobile wallet system 170. The mobile wallet system 170 can include an interface to execute instructions corresponding to a particular wallet account, and to modify the structure or contents of a particular smart contract corresponding to a wallet account. For example, the mobile wallet system 170 can include a user interface to receive input indicating selections of various tokens, transactions, accounts, devices, users, or systems. The user interface can include a graphical user interface that can be presented at a display device. The display device can display at least one or more user interface presentations and can include an electronic display. An electronic display can include, for example, a liquid crystal display (LCD), a light-emitting diode (LED) display, an organic light-emitting diode (OLED) display, or the like. The display device can receive, for example, capacitive or resistive touch input. The mobile wallet system 170 can transmit one or more instructions, tokens, keys, or any combination thereof to, from, or with the data processing system 102.

The client system 103 may be used by a third party with a relationship to the token collateral system 104 or data processing system 102 (e.g., vendor, customer, entity, supplier, and so on) to perform various actions and/or access various types of data, some of which may be provided over network 101. The term “client” as used herein may refer to one or more individuals operating the one or more client systems 103 and interacting with resources or data via the client systems 103. The one or more individuals operating the one or more client systems 103 may of the same party (e.g., entity, institution, etc.) or of different parties. The client system 103 may be used to electronically transmit data (e.g., collateral requests, attributes, tokens) to the data processing system 102, to access websites (e.g., using a browser), to access the internet (e.g., using a mobile application, such as a decentralized application (dApp)), and/or to receive and/or transmit any other types of data.

The client system 103 (e.g., computing system, device, etc.) may be a mobile computing device, desktop computer, smartphone, tablet, smart watch, smart sensor, or any other device configured to facilitate receiving, displaying, and interacting with content (e.g., web pages, mobile applications, such as decentralized application (dApp), etc.). The client system 103 may include an input/output circuit for communicating data over the network 101 to the data processing system 102 and/or the token collateral system 104. In some arrangements, each of the client systems 103 can have a digital wallet address for exchanging (e.g., receiving or sending) fungible or non-fungible values (e.g., cryptocurrency, digital currency, stocks, bonds, loan, deed, etc.).

The token collateral system 104 can transfer one or more tokens between one or more smart contracts, blockchains, systems, wallet accounts, or any combination thereof, or the like based on the detection of a collateral request. For example, in response to receiving a collateral request, the token collateral system 104 can include a collateral network to identify particular tokens and transfer the particular tokens between particular wallet accounts or systems transmitting the collateral request. The token collateral system 104 can receive an instruction to transfer a token from a first account to a second account. In some examples, the instruction to transfer the token can be linked with a quantitative value indicating a value of the token. For example, the quantitative value can correspond to a value of fiat currency, math-based currency (MBC), or any combination thereof. MBC can include cryptocurrency or the like. The token collateral system 104 can detect characteristics associated with particular tokens, types of tokens, or metadata objects linked with the particular tokens, and can detect particular quantitative values corresponding to particular transfer of tokens between accounts.

The ledger 151 provides a record of association for tokens with a token account. For example, the ledger 151 can associated a customer's account with one or more tokens transferred, stored, and/or monitored by the data processing system 102. The ledger 151 may be stored in system memory 150. Each token account for customers may be a single entry in the database. The blockchain storage 158 may be used to track exchanges (e.g., deposits, collateral loans, and updates of tokens) for each of the specific token accounts. The data processing system 102 updates the ledger 151 after each token exchange into and out of the blockchain storage 158. In certain situations, the data processing system 102 may update the ledger 151 without an exchange of a token into or out of the blockchain storage 158. For example, if a first customer wants to transfer a designated token (or portion of a token) to a second customer, and both customers are token account holders with the data processing system 102, the transfer may be effectuated by updating the ledger 151 without an actual exchange of a token in the blockchain storage 158. The transferring and exchanging of fungible and non-fungible values performed or executed by the one or more processors, according to various illustrative arrangements, is described in U.S. patent application Ser. No. 17/528,352, filed Nov. 17, 2021, the entirety of which is incorporated by reference herein.

The ledger 151 can store the associations of tokens with token accounts (e.g., the association between a token account and the tokens owned or partially owned by the token account), while the blockchain storage 158 can store portions of tokens (e.g., smart contracts containing information pointing to the off-chain content and metadata, such as data stored in the token storage 152) and keys of the token (e.g., stored in the key dataset 159). For example, the content and metadata of the token may be stored in an on-chain hash that can point to a storage location of the content and metadata.

The cold storage processor 180 can execute one or more actions with respect to generating (or creating), updating, protecting, and/or destroying cold storage objects in the cold storage ledger 182. In some arrangements, the cold storage processor 180 can communicate with the cold storage ledger 182 via an intermittent secure connection. In some arrangements, the process of establishing an intermittent secure connection can include disconnecting the data processing system 102 from all networks (e.g., internet connections, wired connections, etc.) and connecting via a wired network connection or a wired or wireless local network connection (e.g., local area network (LAN), intra-network, etc.). The connection can be intermittent or discontinuous since the data processing system 102 can perform many functions without having to access the cold storage ledger 182. However, in some arrangements, when an exchange of a token stored on the data processing system 102 is initiated, an intermittent secure connection may be established. In various arrangements, the customer with a token account or the data processing system 102 can add an attribute to each metadata object indicating whether a cold storage exchange must occur when exchanging the particular token. As used herein, “cold storage exchange” refers to the process of performing an exchange of a token using a cold storage object stored on the cold storage ledger 182.

In some embodiments, any data shared over the intermittent secure connection can be encrypted and/or secured (e.g., hashed, password protected, etc.) to prevent unauthorized parties from performing unauthorized actions on the intermittent secure connection. For example, a masking algorithm may be executed performing bitwise operations (e.g., NOT, AND, NAND, OR, XOR, Complement, left-shift (logical or arithmetic), right-shift (logical or arithmetic), rotate right, rotate left, etc.) on any data transferred over the intermittent secure connection. All communications over the intermittent secure connection can be encrypted with one or more secure network protocols (e.g., Secure Shell (SSL), Kerberos, IPsec, Secure Sockets Layer (SSL), Hypertext Transfer Protocol Secure (HTTPS), etc.) implemented utilizing a cryptographic function (e.g., symmetric encryption, asymmetric encryption, hashing, etc.). For example, the cryptographic function could be a homomorphic encryption function. In another example, the cryptographic function could be any symmetric encryption function (e.g., Triple Data Encryption Standard (TDES), RC5, AES, Blowfish, CAST, etc.), and/or asymmetric encryption function (e.g., RSA, Efficient and Compact Subgroup Trace Representation (ECSTR or XTR), Digital Secure, Escrowed Encryption Standard (EES), etc.).

The cold storage processor 180 can use a cold storage data object. The cold storage object can be a data structure that can be structured and formatted for storing data about tokens. For example, each token can include a linked metadata object and the metadata object may include protected and unprotected data. Protected data can include at least one of social security numbers (SSN), passport number, biometric information, geolocation indicating a location of a person, photographs of people, criminal records, credit and/or payment card numbers, health data, among others. Unprotected data can include any data not listed as protected data. The data processing system 102 can identify the presence of protected data. For example, in response to identifying protected data, the cold storage processor 180 may update the metadata object by extracting the protected data and storing the protected data in a newly generated cold storage object. For example, the data processing system 102 can determine, via the link of the token, a first portion of metadata of the metadata object of the token associated with protected data of the token and a second portion of metadata of the metadata object of the token associated with unprotected data of the token, where the first portion of metadata does not contain any data from the second portion of metadata. Furthermore, the cold storage processor 180 can remove or extract the first portion of metadata of the metadata object of the token based on accessing the metadata object via the link, and in turn generate a cold storage object with the protected data and the cold storage private key.

The data processing system 102 may further receive a deposit of tokens from the client system 103, and the client system 103 may have an account with the data processing system 102. For example, the data processing system 102 may encapsulate and deposit the token (e.g., after verifying the digital signature) on the data processing system 102. Additionally, a deposit can include extrapolating (by the token processor 130) various information from the token and storing the information in various storages (e.g., blockchain storage 158, ledger 151, cold storage ledger 182). In another example, a deposit of a token can include updating (e.g., by a ledger 151) a token account of a plurality of token accounts in a ledger 151 by recording ownership of the token with the token account. In the following example, a deposit can further include generating and storing (e.g., by a cold storage processor 180) a first cold storage object in a cold storage ledger 182, where the first cold storage object can include the wallet private key (or internal private key) of the token and at least a first portion of metadata of the metadata object of the token. In the following example, a deposit can further include broadcasting (e.g., by a blockchain storage 158) the token to the blockchain storage 158 at the internal address (e.g., hash of an internal public key).

The data processing system 102, may further receive a deposit of tokens from the client system 103 with a choice for the deposit, and the client system 103 may have an account with the data processing system 102. The deposit may be limited by the choice interface 190 based on the choice specified in the client system 103. The choice interface 190 may maintain a metadata object which specifies the restrictions for the deposit based on the choice of the owner of the account. For example, the data processing system 102 may encapsulate, deposit the token (e.g., after verifying the digital signature), and place restrictions on the deposit (e.g., set by the choice in the deposit and enforced by the choice interface 190) on the data processing system 102. Additionally, a deposit can include extrapolating (by the token processor 130) various information, including the restrictions on the token, from the token and storing the information in various storages (e.g., blockchain storage 158, ledger 151, cold storage ledger 182).

In some embodiments, the interface controller 112 may receive a collateral request (e.g., from the token collateral system 104) of one or more tokens stored on the data processing system 102 where a user (e.g., operating the client system 103) may have an account with the data processing system 102. In response to the collateral request, the data processing system 102 can destroy the token (e.g., after verifying the digital signature) and/or update the storages (e.g., blockchain storage 158, ledger 151, cold storage ledger 182) based on the successful withdrawal or exchange of tokens specified in the collateral request. Destroying the token can including voiding or burning the token since the public-private key pair would be invalid (e.g., cannot be used to sign or verify an exchange). Voiding or burning can include transmitting the token to an un-spendable address (e.g., where no one knows the private key). That is, while the blockchain storage 158 may not destroy or update the token when they are exchanged to a different ledger or off-chain, the token on the sender's ledger would be unusable or unvalued.

The blockchain storage 158 (sometimes referred to herein as a “blockchain ledger”) described herein generally. The blockchain storage 158 (or ledger) can include the key dataset 159 and a blockchain. The blockchain storage 158 can be configured to store and/or maintain any of the information described herein (e.g., tokens or portions of tokens, smart contracts, public and private key pairs, etc.). In some arrangements, the described ledger systems and methods involve utilizing one or more processors. The one or more processors allow receiving, collecting, and sending of environmental data, collateral requests (e.g., withdrawal, deposit), public and private key pairs, attributes, smart contracts, and so on. The one or more processors can then communicate with one or more nodes of the blockchain storage 158 and execute one or more smart contracts stored on the nodes to perform various checks (e.g., signing, verifying, distributing, exchanging).

The blockchain storage 158 can include a plurality of nodes configured to store a copy of a plurality of tokens. In various arrangements, each node may contain a copy of an individual token associated with a token account of the data processing system 102. In various arrangements, the plurality of nodes on the blockchain storage 158 can be interconnected via a central node (e.g., centralized or generalized). Indeed, each node can perform various operations (e.g., execute smart contracts, update tokens) on-chain (e.g., on blockchain storage 158) or off-chain. Thus, the central node can operate as an intermediary between any system or device with data not stored on the blockchain storage 158 such that, any communications (e.g., collateral requests, withdrawals or deposits, updates, public and private key access) first is received by the central node. As such, the central node may be configured to route communications and/or query one or more nodes on the blockchain storage 158 upon receiving a communication from any system or device described herein. In some arrangements, the central node may be a token and may be the root node (e.g., the originally created token), and any additional nodes added may be attached (e.g., appended, pre-pended, linked, associated, embedded) to the central node via one or more communications networks (e.g., public, private, shared, and so on). In various arrangements, the central node may be a dummy asset that stores data (e.g., addresses) to communicate with the other nodes on the blockchain storage 158.

The key dataset 159 can include a plurality of public and private key pairs (referred to hereafter as “key pairs”). In some arrangements, the key dataset 159 may include a public key and a pointer (e.g., cold storage public key, hash address, or cold storage address) to a cold storage object stored in cold storage ledger 182. In some arrangements, the key dataset 159 can include a hardware security module (HSM) that can manages cryptographic keys. Each key pair can be stored in the key dataset utilizing a cryptographic function. For example, the cryptographic function could be a homomorphic encryption function. In another example, the cryptographic function could be any symmetric encryption function (e.g., TDES, RC5, AES, Blowfish, CAST, and so on), and/or asymmetric encryption function (e.g., RSA, ECSTR or XTR, Digital Secure, EES, and so on). In some arrangements, the private key can be used to encrypt tokens (e.g., using a cryptographic function to sign) at the source system when an exchange occurs (e.g., send token from a source address to a destination address). In various arrangements, the public key can be used by the destination system to decrypt (e.g., verify) the encrypted token. For example, the sender (source) of a token stored in a digital wallet can sign (e.g., “lock”) the token or data package including the token to be exchanged with a private key stored in a digital wallet or on the user device of the user and in turn, transmit the token and share the public key for verifying (e.g., “un-locking”) by the receiver, such as the data processing system 102. Additionally in some arrangements, the public key can be used to encrypt tokens and the private key can be used to decrypt the encrypted tokens. For example, the sender (source) of a token stored in a digital wallet can sign the exchange with a public key of and shared by the receiver (destination), and the receiver can in turn, verify the received token and/or data package including the token using the private key of the receiver.

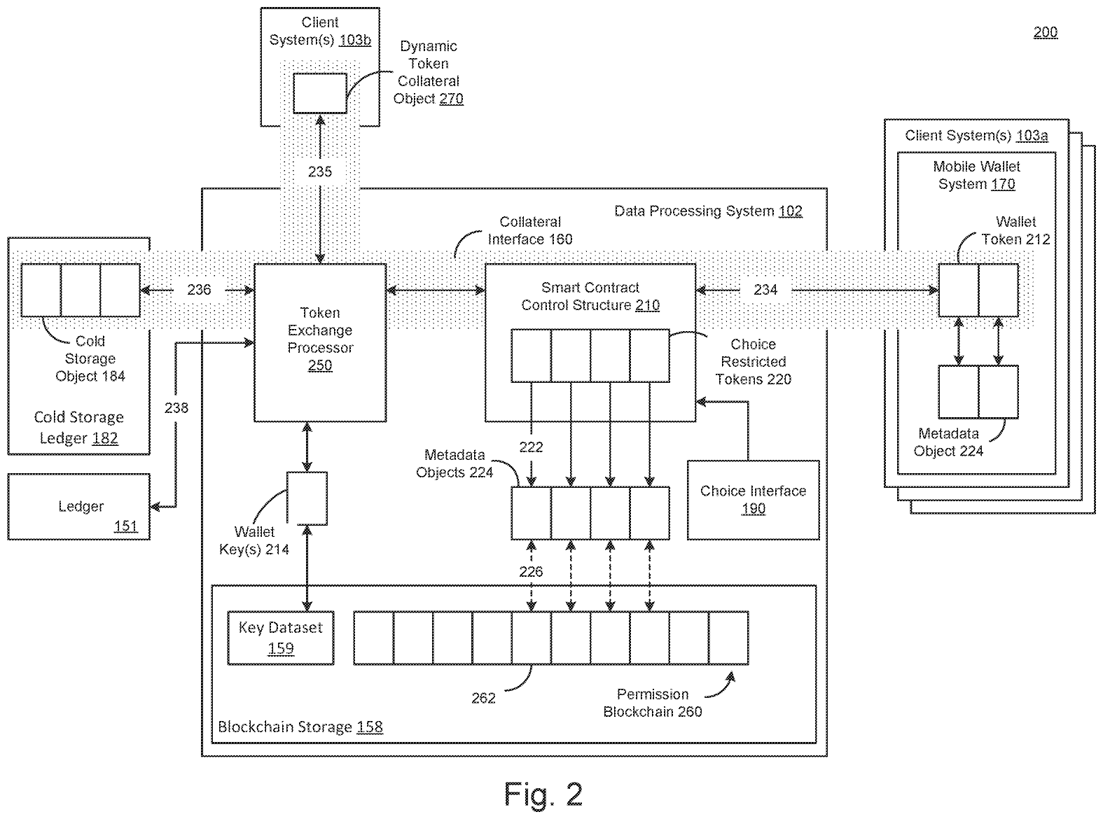

Referring now to FIG. 2, an example digital asset architecture is shown. The example digital asset architecture 200 can include at least the data processing system 102, the client system 103a, the client system 103b, the ledger 151, the blockchain storage 158, the key dataset 159, the mobile wallet system 170, the collateral interface 172, the cold storage ledger 182, the cold storage object 184, a smart contract control structure 210, wallet tokens 212, wallet key(s) 214, one or more choice restricted tokens 220, one or more metadata links 222, one or more metadata objects 224, one or more blockchain links 226, internal key(s), a client link 234, a client link 235, a cold storage link 236, a ledger link 238, a token transaction processor 250, a permission blockchain 260 with one or more blocks 262, and a dynamic token collateral object 270.

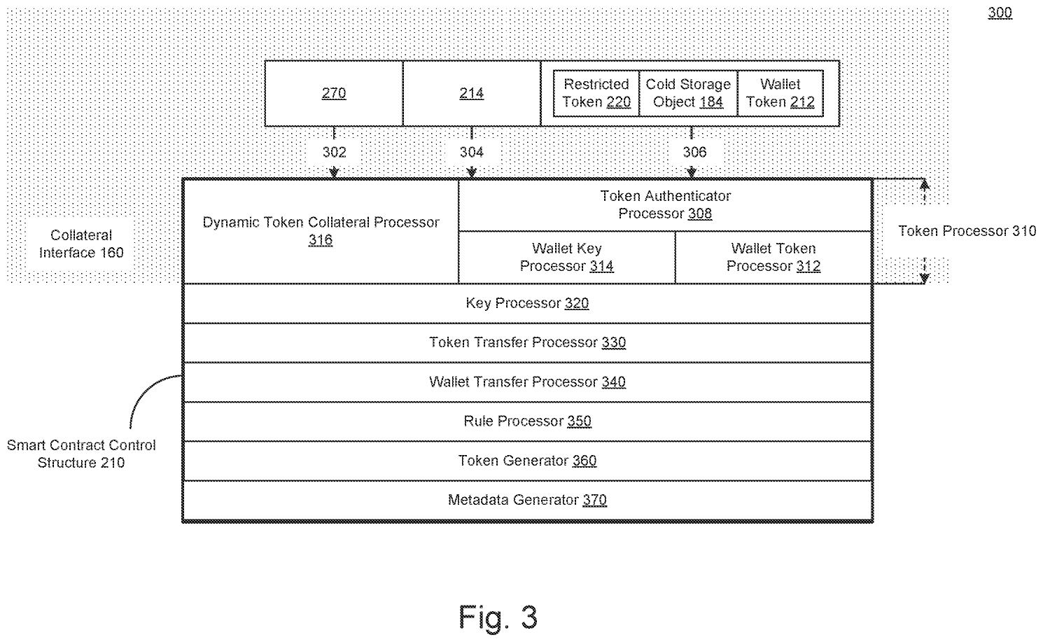

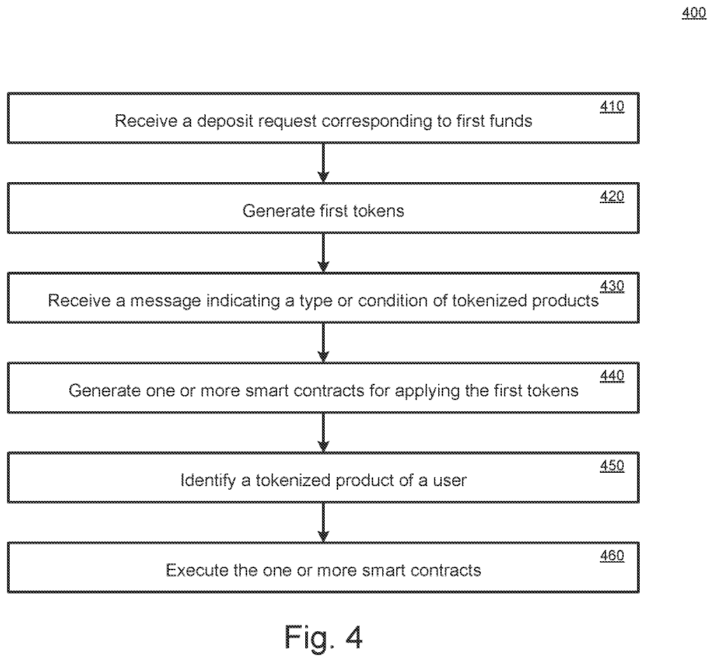

The wallet key(s) 214 can include a key compatible with the wallet token 212. The wallet key(s) 214 can be stored in the key dataset 159 and received by a token authenticator processor 308 via a wallet key transmission 304 (as disclosed herein with respect to FIGS. 3 and 4). The mobile wallet system 170 can execute a transaction or modify metadata of the wallet token 212 in response to detecting input including the wallet key 214. The wallet keys 214 can, for example, include a wallet public-private key pair, a wallet public key, or a wallet private key compatible with the mobile wallet system 170. The mobile wallet system 170 can permit access to the wallet token 212 based on the wallet key(s) 214, for example, compatible with the encapsulation layer and operable to decrypt the encryption corresponding to the encapsulation layer.

The wallet keys 214 (e.g., wallet public-private key pair) can correspond to a cryptographic key pair linked with a particular token account and the wallet token 212. For example, the wallet keys 214 can be used to “lock” and “unlock” the wallet token 212 on the mobile wallet system 170. In the above example, the mobile wallet system 170 can transmit the wallet token 212 and the wallet keys 214 when depositing the wallet token 212 at the data processing system 102. In some arrangements, an action can include transferring a token to a particular token account or smart contract. Transferring the token to the particular token account may include updating an entry in the ledger 151 but not broadcasting the token to the permission blockchain 260. In another example, a deposit action can include registering a token to a particular token account on the ledger 151 and broadcasting the token to the permission blockchain 260, or any combination thereof.

The choice interface 190 can include restrictions for one or more tokens and keys corresponding to various accounts and communicate with the client system 103a. For example, the choice interface 190 can dictate how the tokens can be used and the smart contract control structure 210 can generate choice restricted tokens 220. For example, the choice interface 190 can determine who the choice restricted tokens 220 can be transmitted to. The choice interface 190 can include an interface compatible with the token collateral processor 250 and the collateral interface 172.

The smart contract control structure 210 can include one or more instructions to restrict and transmit output of one or more of the choice restricted tokens 220. The smart contract control structure 210 can correspond to an executable smart contract and can include a gateway component. The gateway component can include one or more instructions to restrict or prevent output of the choice restricted tokens 220. The smart contract control structure 210 can include an encapsulation layer that (shown as smart contract control structure 210), for example, maintains the restricted tokens in an encrypted state. The smart contract control structure 210 can permit access to the choice restricted tokens 220 based on a private key, for example, compatible with the encapsulation layer and operable to decrypt the encryption corresponding to the encapsulation layer. The smart contract control structure 210 can permit access to the choice restricted tokens 220 based on the choice interface 190. For example, the smart contract control structure 210 can decrypt the choice restricted tokens 220 upon the satisfaction of rules presented by the choice interface 190 and based on the private key. The smart contract control structure 210 can be registered to the permission blockchain 260 by a block link with the permission blockchain 260.

The choice restricted tokens 220 can include a specific token and correspond to metadata objects 224. Furthermore, the specific token can correspond to a specific rule presented by the choice interface 190. The choice restricted token 220 can be associated with a specific metadata object 224 and can be required to transmit the output of the metadata object, transfer the metadata object to another storage location, or any combination thereof. Each of the choice restricted tokens 220 can indicate control of a particular metadata object of the metadata objects 224 by a corresponding metadata link of the metadata links 222. The metadata links 222 can include a reference, pointer, or the like, to or between each restricted token and each metadata object associated with that particular restricted token. The choice restricted tokens 220 can have various aspects or characteristics that can correspond to the wallet tokens 212. For example, a restricted token among the choice restricted tokens 220 can be associated with a type corresponding to or matching a type of the wallet token 212.

The collateral interface 172 can include a communication channel between one or more of the smart contract control structures 210, the token transaction processor 250, the wallet token 212 at the mobile wallet system 170, and the cold storage object 184 at the cold storage ledger 182. The collateral interface 172 can include an application programming interface compatible with the smart contract control structure 210 to detect the wallet key(s) 214 and the internal key(s) at the data processing system 102, the cold storage object 184 at the cold storage ledger 182, and the wallet token 212 at the mobile wallet system 170. At least one of the collateral interface 172 or the smart contract control structure 210 can execute one or more instructions to determine whether one or more of the wallet key 214, internal keys, the dynamic token collateral object 270, or the wallet token 212 are compatible with the container and/or smart contract control structure 210. The collateral interface 172 can include the wallet token 212 and the client link 234. The client link 234 can include a transmission path or communication path between the wallet token 212 and the smart contract control structure 210 by the collateral interface 172. At least one of the collateral interface 172 or the smart contract control structure 210 can detect the wallet token 212 via the client link 234.

The wallet token 212 can identify a token and can identify one or more characteristics linked with the token or corresponding to a request to transfer the token (e.g., deposit, withdrawal, update). For example, the wallet token 212 can include an identifier of the token, a hash of the token, an identifier of a token account linked with the token, a token account linked with the request to transfer the token, an identifier of a public-private key pair or any portion thereof, or any combination thereof. For example, the wallet token 212 can include an identification of a public-private key pair corresponding to a smart contract control structure of an owner of a token. In another example, the wallet token 212 can include an identification of a public-private key pair corresponding to a smart contract control structure of a buyer of a token. The client link 234 can transmit the wallet token 212 from the client system 103a or the mobile wallet system 170 to the data processing system 102 (in particular, the token transaction processor 250) or the smart contract control structure 210.

The token transaction processor 250 can execute one or more actions with respect to various cryptographic keys, tokens, containers, control structures, and smart contracts. For example, the token transaction processor 250 can modify links between various containers, control structures, token, and smart contracts with various public-private key pairs. The token transaction processor 250 can transfer public-private key pairs based on one or more operations of the cryptographic key processor 120, for example. The token transaction processor 250 can generate and modify one or more metrics corresponding to various tokens, including the wallet tokens 212 and the choice restricted tokens 220, based on one or more operations of the token processor 130. The token transaction processor 250 can generate or modify one or more containers, tokens accounts, or smart contracts, based on one or more operations of the smart contract engine 150.

The token transaction processor 250 can execute one or more actions with respect to generating the cold storage objects 184 and storing the cold storage objects 184 in the cold storage ledger 182. In some arrangements, the token transaction processor 250 can establish an intermittent secure connection with the cold storage ledger 182 over the cold storage link 236. The token transaction processor 250 can also execute one or more actions with respect to generating token accounts for the ledger 151, recording associations of choice restricted tokens 220 with one or more token accounts of the ledger 151, and updating the ledger 151. In some arrangements, the token transaction processor 250 can establish a connection with the ledger 151 over the ledger link 238.

The permission blockchain 260, within the blockchain storage 158, can include at least one blockchain including one or more of the blocks 262. The permission blockchain 260 can be linked with one or more of the metadata objects 224, the choice restricted tokens 220, or the smart contract control structures 210. The permission blockchain 260 can include a blockchain operated and controlled at the data processing system 102. The permission blockchain 260 can include a plurality of blockchains each corresponding to particular aspects of the links associated with the corresponding blockchains. The permission blockchain 260 can include the blocks 262, and the key dataset 159 can include the wallet keys 214, and/or other keys such as cold storage keys. The blocks 262 can include or store links to one or more objects associated with the permission blockchain 260. The keys stored in the key dataset 159 can include a reference, pointer, or the like, to or between a block among the blocks 262 and the keys associated with that particular block. For example, the wallet key 214 can include a reference, pointer, or the like, to or between a block among the blocks 262 and the wallet token 212 associated with that particular block.

Referring now to FIG. 3, an example digital asset structure is shown. The example digital asset structure 300 can include at least the collateral interface 150, the smart contract control structure 210, a dynamic token collateral transmission 302, a wallet key transmission 304, and a token/object transmission 306, a token processor 310 including a token authenticator processor 308, a wallet-internal token processor 312, a wallet-internal key processor 314, a dynamic token collateral processor 316, a key processor 320, a token transfer processor 330, a wallet transfer processor 340, a rule processor 350, a token generator 360, and a metadata generator 370.

The wallet key transmission 304 can be responsive to an action by the collateral interface 172 to transmit the wallet key 214 to the smart contract control structure 210. The token/object transmission 306 can be responsive to an action by the collateral interface 172 to transmit the wallet token 212, the restricted token 220, and/or the cold storage object 184 to the smart contract control structure 210. That is, the token/object transmission 306 can be one or more of the wallet tokens 212, the choice restricted token 220, and/or the cold storage object 184 received from one or more of the cold storage ledgers 182, the blockchain storage 158, and/or the mobile wallet system 170, via the collateral interface 172.

The token processor 310 can query the ledger 151 for token account information associated with the choice restricted token 220 or the wallet token 212. For example, in response to the token processor 310 receiving the choice restricted token 220 or the wallet token 212, the token authenticator processor 308 can determine if a token account has been generated for the received choice restricted token 220 or the wallet token 212. Furthermore, the token processor 310 can generate a rule corresponding to the token account based on the choice interface 190. The token processor 310 can embed the rule in the choice restricted token 220 to restrict the use of the token by the financial institution. Moreover, if a token account has been created, the token processor 310 may update the ledger 151 recording the token identifier with a particular token account. Furthermore, if a token account has not been created, the token processor 310 may provide the ledger 151 with information to generate a token account and record the token identifier with the newly generated token account.

The token processor 310 can communicate with, authenticate, and update various tokens and NFTs. The token processor 310 can include one or more interfaces corresponding to an API or a smart contract interface, for example. A smart contract interface can include one or more executable instructions integrated with a smart contract. The smart contract interface can execute instructions at the smart contract or triggered by the smart contract in response to detection of objects or conditions external to the smart contract. The token processor 310 can include at least a portion of a control structure of the smart contract.

The token authenticator processor 308 can determine whether a token of the smart contract control structure 210 is compatible with a transfer (e.g., downpayment loan, collateral) based on the rule or an intended customer segment from the choice interface 190. The intended customer segment can include a particular type of business, a particular type of user, geographic regions, uses, among others. The rule can include a threshold for the tokens requested, the amount of time for the loan to be repaid, the amount of the loan, defaults, interest, amendments, etc.). For example, the token authenticator processor 308 can include one or more metrics indicating that tokens having aspects or characteristics that satisfy the rule or intended customer segment can be transferred to or from the smart contract control structure 210. For example, a particular token of the smart contract control structure 210 may be incompatible with a transfer (e.g., deposit, withdrawal) or restricted from transfer because of a violation of the rule or an incorrect intended customer segment. For example, the token authenticator processor 308 can include or reference a transfer restriction, based on the violation of the rule or the incorrect intended customer segment, linked with a minting restriction and can block execution of a transfer of the token from or to the mobile wallet system 170 in response to detecting the violation of the rule and the incorrect intended customer segment. For example, the token authenticator processor 308 can include or reference a transfer authorization, based on the rule and the intended customer segment, linked with a minting parameter and can permit or initiate execution of a transfer of the token from or to the blockchain storage 158 in response to detecting the minting parameter linked with the transfer authorization. For example, the token authenticator processor 308 can link with the smart contract control structure 210 and receive an identification of or reference to a particular token. The token authenticator processor 308 can then determine one or more characteristics or aspects of the particular token associated with the request to transfer the particular token, in response to receiving a transmission from or via the mobile wallet system 170 and/or the token transaction processor 250.

The token authenticator processor 308 can detect the presence of a fungible token or NFT and can determine whether the token is compatible with the smart contract control structure 210. The token authenticator processor 308 can be configured to be compatible with a particular fungible token or can be generated to be compatible with a particular fungible token. The token authenticator processor 308 can be configured to be compatible with a plurality of tokens having a particular characteristic or can be generated to be compatible with a plurality of tokens having a particular characteristic. A particular characteristic can include, for example, a particular identifier or portion of an identifier of a token. For example, the token authenticator processor 308 can be integrated with or store a hash based on a particular fungible token and a hash processor operable to generate a hash based on any fungible token. The token authenticator processor 308 can generate a hash in response to detecting the presence of the fungible token and can determine whether the fungible token is compatible with the smart contract control structure 210, in response generating the hash, by comparing the generated hash with the stored hash. The token authenticator processor 308 can include logic to detect a fungible token passed to it, by, for example, an activation instruction from the collateral interface 172.

The token authenticator processor 308 can authenticate links of tokens based on successfully accessing, via the link, the metadata object of the tokens. The link can be the Token URI (a unique identifier of what the token “looks” like) or another link that can be provided to a token lookup table, a Uniform Resource Locator (URL), a world-wide-web address, an internal network address, an HTTPS, an Interplanetary File System (IPFS) hash, and so on. In various arrangements, authenticating the link can include scanning and/or analyzing a token exchange, such as the token collateral system 104, to verify the received token is not stored on or being sold on the token exchange. In some arrangements, the token authenticator processor 308 can also collect on-chain data related to the token by accessing the previous public address (prior to transferring the token and encapsulating it within the smart contract control structure 210) and determine if the on-chain data (e.g., previous transaction history, owner, metadata, etc.) is consistent with the metadata of the received token.

The wallet token processor 312 can detect the presence of the wallet token 212, the choice restricted token 220, and/or the cold storage object 184, and can extract one or more attributes, parameters, aspects, or values, or any combination thereof, from at least one of the wallet token 212, the choice restricted token 220, and/or the cold storage object 184. The wallet token processor 312 can be configured to be compatible with the wallet token 212, the choice restricted token 220, the cold storage object 184, the collateral interface 172, the token collateral system 104, and/or the mobile wallet system 170. Thus, the wallet-token processor 314 can provide direct communication between the data processing system 102, the mobile wallet system 170, the token collateral system 104, the cold storage ledger 182, and the ledger 151. The wallet token processor 312 can include a token profile or collateral profile corresponding to a particular token collateral system and compatible with a particular token.

The wallet token processor 312 can detect the presence of a semi-fungible token (or NFT) and can determine whether the semi-fungible token is compatible with the wallet token processor 312. The wallet token processor 312 can be configured to be compatible with a particular semi-fungible token or can be generated to be compatible with a particular semi-fungible token. The wallet-internal token processor 314 can be configured to be compatible with a plurality of tokens having a particular characteristic or can be generated to be compatible with a plurality of tokens having a particular characteristic. A particular characteristic can include, for example, a particular identifier or portion of an identifier of a token. For example, the wallet-internal token processor 314 can be integrated with or store a hash based on a particular semi-fungible token and a hash processor operable to generate a hash based on any semi-fungible token. The wallet-internal token processor 314 can generate a hash in response to detecting the presence of the semi-fungible token and can determine whether the semi-fungible token is compatible with the smart contract control structure 210, in response generating the hash, by comparing the generated hash with the stored hash. The wallet-internal token processor 314 can include logic to detect a semi-fungible token passed to it, by, for example, an activation instruction from the mobile wallet system 170.

The wallet-internal token processor 314 can also detect the presence of a fungible token and can determine whether the fungible token is compatible with the wallet-internal token processor 314. The wallet-internal token processor 314 can be configured to be compatible with a particular fungible token or can be generated to be compatible with a particular fungible token. The wallet-internal token processor 314 can be configured to be compatible with a plurality of tokens having a particular characteristic or can be generated to be compatible with a plurality of tokens having a particular characteristic. A particular characteristic can include, for example, a particular identifier or portion of an identifier of a token. For example, the wallet-internal token processor 314 can be integrated with or store a hash based on a particular fungible token and a hash processor operable to generate a hash based on any fungible token. The wallet-internal token processor 314 can generate a hash in response to detecting the presence of the fungible token and can determine whether the fungible token is compatible with the smart contract control structure 210, in response generating the hash, by comparing the generated hash with the stored hash. The wallet-internal token processor 314 can include logic to detect a fungible token passed to it, by, for example, an activation instruction from the mobile wallet system 170.

The wallet key processor 314 can detect the presence of the wallet key 214, and can extract one or more metrics, parameters, aspects, or values, or any combination thereof, from the wallet token 212, the cold storage object 184, and/or the choice restricted token 220. The wallet key processor 314 can be configured to be compatible with the wallet token 212, the cold storage object 184, and/or the restricted token 220, the collateral interface 172, the token collateral system 104, the mobile wallet system 170, the cold storage ledger 182, and/or the ledger 151.

The key processor 340 can generate, transfer, and modify various cryptographic keys. The key processor 320 can transfer one or more of the account key pairs (e.g., the wallet keys 214, internal keys, etc.) to or from the container of the smart contract control structure 210. For example, the key processor 320 can transfer a cryptographic key pair, a public key, a private key, a symmetric key, or any combination thereof, to or from the container to indicate a change in control of a particular token account to the container. The key processor 320 can access a particular token account in the ledger 151. For example, the key processor 320 can identify a token account associated with internal keys (e.g., public-private key pair). For example, the key processor 320 can transmit a hash based on the internal keys to the mobile wallet system 170 associated with the token account. The key processor 320 can generate a corresponding number of “internal keys” or “wallet keys” such as “public and private key pairs” that can control restrictions on output by the particular metadata object linked with the particular smart contract control structure 210 compatible with the particular token.

The token transfer processor 330 can transfer and modify various tokens. The token transfer processor 330 can include an API compatible with the permission blockchain 260. The token transfer processor 330 can selectively add, modify, and delete blocks (e.g., the blocks 262, etc.) from the permission blockchain 260. The token transfer processor 330 can add, modify, and delete blocks in accordance with restrictions or interfaces of the permission blockchain 260, and can add, modify, and delete blocks independently of the restrictions or interfaces of the permission blockchain 260 at any portion or index of the permission blockchain 260. The token transfer processor 330 can transfer the choice restricted token 220 to or from the smart contract control structure 210. For example, the token transfer processor 330 can transfer a token in response to an indication by the key processor 320 that a token account is linked with and authorized to a particular token account.

As used herein, an “on-us exchange” or “on-us transaction” is an exchange of a token between tokens accounts of the ledger 151. In some arrangements, the ledger 151 can be shared with other data processing systems external or remote to the data processing system 102. For example, the other data processing system may be another financial institution or provider of token exchanges. In some arrangements, the token transfer processor 330 can transfer and modify the ledger 151 based on receiving an exchange request between customers that have a token account with the ledger 151. Accordingly, the token transfer processor 330 can execute an on-us exchange by updating the ledger 151 to record the new ownership of the token being exchanged.

The wallet transfer processor 340 can transfer and modify various tokens. The wallet transfer processor 340 can include an API compatible with the mobile wallet system 170. The wallet transfer processor 340 can selectively deposit, withdraw, or update tokens stored on the mobile wallet system 170. The wallet transfer processor 340 can deposit, withdraw, or update tokens in accordance with restrictions or interfaces of the mobile wallet system 170, rules of the tokens based on the choice interface 190, or the intended customer segment embedded in the token, and can deposit, withdraw, or update tokens independently of the restrictions or interfaces of the mobile wallet system 170 at any portion or index, rules of the tokens based on the choice interface 190, or the intended customer segment embedded in the token. The wallet transfer processor 340 can transfer the choice restricted token 220 to or from the smart contract control structure 210. For example, the wallet transfer processor 340 can transfer a token in response to an indication by the key processor 320 that collateral or a downpayment loan is requested by the mobile wallet system 170.

The rule processor 350 can generate or define a plurality of rules to be enforced by one or more smart contracts. The rule processor 350 can include an API compatible with the mobile wallet system 170 and the choice interface 190. The plurality of rules can restrict the use of the tokens associated with the mobile wallet system 170. Each rule can be associated with the metadata object 224 corresponding to one or more wallet tokens 212 of the mobile wallet system 170. The rule processor 350 can include an API compatible to receive a loan and generate a plurality of rules from the loan. For example, the rule processor 350 can generate a rule, based on the choice from the choice interface 190, which determines the length of the loan. In another example, the rule processor 350 can define a plurality of rules, based on the choice interface 190, corresponding to a plurality of choices defined by the choice interface 190, selected by a depositor.

The token generator 360 can generate one or more tokens in accordance with a metadata object. For example, the token generator 360 can generate multiple tokens based on a number of new metadata objects or tokens indicated by an obtained token. For example, the token generator 360 can generate one or more tokens each including a link or a reference to a parent (or primary) token (e.g., the choice restricted token 220, etc.) to identify a source token corresponding to the token minted by the token generator 360 (e.g., for a physical asset or a digital asset). For example, the token generator 360 can generate one or more tokens each including a link or a reference to a token from which the new tokens are minted. Thus, the token generator 360 can validate a minting of a token based on a parameter embedded in the token. The parameter can include a hash of the parent token or the token from which the new tokens are minted, for example. Generating a token and minting a token can be used interchangeably.

The token generator 360 can generate one or more tokens in accordance with a token or a control structure. For example, the token generator 360 can generate multiple tokens based on a number of new metadata objects or tokens indicated by an obtained token and linked with respective smart contract control structures. For example, the token generator 360 can generate one or more content tokens each linked with a particular smart contract control structure (e.g., the smart contract control structure 210, etc.) with which the respective token is compatible. The token generator 360 can modify and delete tokens linked with primary tokens or parent smart contract control structures, to update control of a partial transfer of metadata object control. For example, the token generator 360 can create a token controlling 25% of shares of a physical or digital asset and modify a token originally controlling 100% of the asset to link with a smart contract control structure controlling 75% of the asset. The token generator 360 can make the modification in accordance with an example for a change in control of 25% of the asset controlled by the original token holder.

The token generator 360 can generate one or more tokens in accordance with one or more choices defined by the choice interface 190. For example, the token generator 360 can generate multiple tokens based one or more choices indicated by the choice interface 190 and linked with the respective smart contract control structures. For example, the token generator 360 can generate one or more tokens each linked with a particular smart contract control structure (e.g., the smart contract control structure 210) with which the respective token is compatible. The token generator 360 can embed intended customer segments in the token to identify how the token can be used by a borrower or a financial institution. For example, the token generator 360 can embed particular borrower information (e.g., identification, characteristics, etc.) to restrict the use of the token to the particular borrower.

The metadata generator 370 can generate one or more metadata objects in accordance with a received request with third-party data (e.g., various data sources). For example, the metadata generator 370 can generate multiple tokens based on a number of new metadata objects indicated by a loan, deposit, or update from the mobile wallet system 170, and linked with respective smart contract control structures (e.g., the smart contract control structure 210, etc.). For example, the metadata generator 370 can generate one or more metadata objects each linked with a particular smart contract control structure (e.g., the smart contract control structure 210) by which the respective metadata object is controlled. The metadata generator 370 can modify and delete metadata objects linked with tokens or the smart contract control structures 210.

The metadata generator 370 can modify a quantitative value corresponding to a token. For example, a quantitative value corresponding to a token can indicate a value of fiat currency or MBC currency. The metadata generator 370 can modify the quantitative value of the token based on a determined value (such as from off-chain data) to generate a scaled quantitative value. For example, a token having a quantitative value of 10,000 denominated in United States Dollar (USD) can be scaled based on a determined value of 0.1 to 1,000. The token scaler can perform any linear or non-linear transformation on a quantitative value and is not limited to the example product transform discussed herein.

The dynamic token collateral processor 316 can detect the presence of the dynamic token collateral object 270 and can extract one or more attributes, parameters, aspects, or values, or any combination thereof, from the dynamic token collateral object 270. The dynamic token collateral transmission 301 can be responsive to an action by the collateral interface 172 to transmit the dynamic token collateral object 270 to the smart contract control structure 210 or the token transaction processor 250. The dynamic token collateral processor 316 can determine whether the dynamic token collateral object 270 is compatible with the dynamic token collateral processor 316. The dynamic token collateral processor 316 can be configured to be compatible with a particular dynamic token collateral object (e.g., the dynamic token collateral object 270, etc.), or can be generated to be compatible with the particular dynamic token collateral object. For example, the dynamic token collateral object 270 can link with the smart contract control structure 210 and receive an identification of or reference to a particular token. The dynamic token collateral processor 316 can then determine one or more characteristics or aspects of the token associated with the dynamic token collateral object 270, in response to receiving a transmission from or via the client system 103 including the dynamic token collateral object 270.

Referring now to FIG. 4, a flowchart for a method 500 to facilitate asset exchanges utilizing tokens (e.g., fungible tokens, semi-fungible tokens, NFT, etc.) in accordance with present implementations. At least one of the example systems 100 and 200 or the example structure 300 can perform method 500 according to present implementations. It is to be appreciated that additional, fewer, or different operations (e.g., steps, sub steps, etc.) than what is described herein may be performed depending on the particular arrangement. In some embodiments, some, or all operations of method 500 may be performed by one or more processors executing on one or more computing devices, systems, or servers. In various embodiments, each operation may be re-ordered, added, removed, or repeated.

At block, 410, the one or more processors (e.g., token processor 130, system processor 110) can receive a deposit corresponding to a first funds (linked by the interface controller 112). The deposit can be received from a first computing system (e.g., the client system 103, the third-party device, another system or device connected to network 101, etc.), by a depositor. The deposit can include or be defined/identified by information such as, but not limited to, an origin funds account (e.g., a cash account, a digital cash account, a fiat currency account, a cryptocurrency account, etc.) associated with the first computing system, a receiving funds account associated with the one or more processors, asset information (e.g., fund currency, fund amount, etc.), images and videos of the asset, asset identifier, user information (e.g., blockchain address, wallet address, public and private key pair, public key, private key, account information, location information, exchange history), and so on. The public and private key can be used by a cryptographic key processor (e.g., cryptographic key processor) to generate an address for a digital wallet corresponding to the funds account. Receiving the deposit may include the one or more processors receiving a confirmation of, or confirming, a transfer of the first funds from the origin funds account to the receiving funds account. The first funds may include fiat currency, MBC currency, central bank digital currency (CBDC) currency, cryptocurrency, digital currency, stocks, bonds, loan, deed, etc.).

At block 420, the one or more processors (e.g., token processor 310 using a token generator 360) can generate first tokens by tokenizing the first funds. The one or more processors generate the first tokens in response to receiving the first funds. Tokenizing the first funds includes generating a funds metadata object (via a metadata generator 370) that includes metadata of the first funds and at least one of a type or condition of the tokenized products to which the first token is applied. The first token includes a link (e.g., Token URI (a unique identifier of what the token “looks” like) or another link that can be provided to a token lookup table, a URL, a world-wide-web address, an internal network address, a Hypertext Transfer Protocol Secure (HTTPS)) to the funds metadata object. The one or more processors can obtain metadata of the tokenized product (e.g., the first funds, video, code, audio, manuscripts, art, public and private key pair, media, etc.). Generating first tokens includes using a private key to create the first tokens. The private key is generated by a first digital wallet and maintains a pointer to an address of the first digital wallet. The private key can be used to create a public key corresponding to the depositor (via the cryptographic key processor 120 or the wallet key processor 314). The public key can associate the depositor to the first tokens and can identify the depositor. The one or more processors can mint the first tokens using the private key by executing a smart contract. The one or more processors can authenticate metadata (e.g., tokenized product) corresponding to the first tokens associated with the private key. The authenticated data can be used to create a new block (e.g., block 262) on a blockchain (e.g., blockchain storage 158) to store information associated with the tokenized product, an asset, or a representation of the first funds. The information can be recording onto the blockchain using a protocol (e.g., proof of stake, etc.).

At block 430, the one or more processors can receive a message (e.g., via a collateral interface 160) indicating the type or the condition of the tokenized products. The message can be one of a short message service (SMS), multimedia message service (MMS), instant message (IM), rich communication services (RCS), mobile push notification, among others. The message can include a definition, an indication, or a selection to identify the type or condition of the tokenized products. The type or the condition of the tokenized products can be selected from the first computing system by the depositor over the network. The type or condition of the tokenized product can identify an intended customer segment (e.g., a particular type of business, a particular type of user, geographic regions, uses, etc.). A determination by the depositor can specify the intended customer segment (e.g., via the choice interface 190). The one or more processors can embed the intended customer segment as the condition in the first tokens or as a type for the first tokens. The first token can include a metadata object configured to hold the intended customer segment, tokenized product information, and fungible token corresponding to currency (e.g., fiat currency, Bitcoin, Dogecoin, Peercoin, etc.) corresponding to the first funds.

At block 440, the one or more processors can generate one or more smart contracts (via a smart contract engine 140 and stored in a smart contract storage 156) for applying the first tokens to the at least one of the type or the condition of the tokenized product. The one or more smart contracts can be generated for a particular depositor or for a plurality of depositors. The particular depositor can use the determination to influence the one or more smart contracts to correspond to the tokenized product of the first funds. The plurality of depositors can have a similar determination and the one or more processors can generate a smart contract to distribute to each of the blocks on the blockchain corresponding to each of the depositors in the plurality of depositors.

At block 450, the one or more processors can identify a tokenized product of a user with the type of the tokenized products. The tokenized product can include at least one attribute that fulfills the condition. The attribute can include identification (e.g., passport number, driver's license, social security numbers (SSN), green cards, optional practical training (OPT), voter registration, among others), characteristics (e.g., spending habits, loan history, transaction history, location history, IP Address from a client device 103, among others), or a borrower input (e.g., student loan, mortgage, car loan, debt loans, credit loans, interest loan, among others) of the user. The type of the tokenized products can include an identification for a group of products or services corresponding to a providing funds or tokens associated with the user. The providing funds can be a deposit made by the user into a funds account. The providing tokens can be generated based on the providing funds of the user.

At block 460, the one or more processors, execute the one or more smart contracts to apply the first tokens to the tokenized product of the user. Applying the first tokens to the tokenized product of the user can include transferring the first funds, the first tokens, or the tokenized product associated with the depositor. Executing the one or more smart contracts can include executing a first contract when a borrow matches the intended customer segment. The borrow may include a metadata object to identify information about the borrow. The metadata object can include metadata corresponding to the borrow, identification of the user initiating the borrow (referred to as a borrower), a second funds associated with the borrow correspond to a second digital wallet, and the intended customer segment.

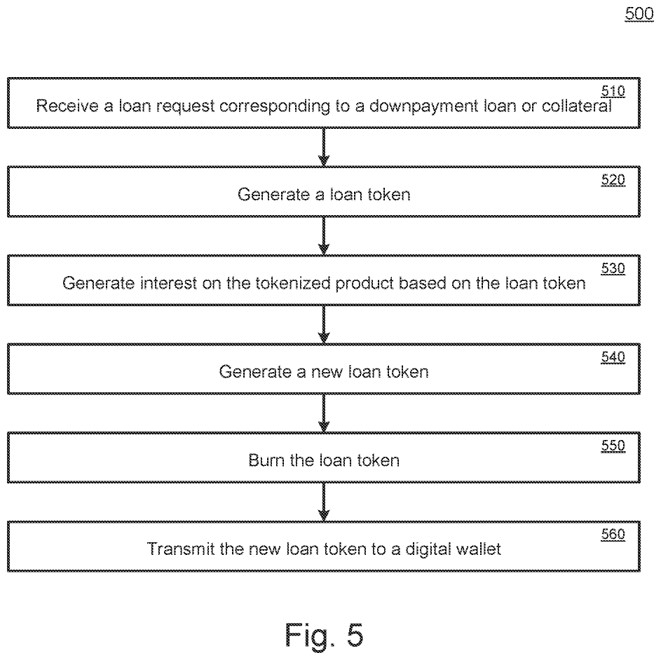

Referring now to FIG. 5, a flowchart for a method 500 to facilitate asset exchanges utilizing tokens (e.g., fungible tokens, semi-fungible tokens, NFT, etc.) in accordance with present implementations. At least one of the example systems 100 and 200 or the example structure 300 can perform method 500 according to present implementations. It is to be appreciated that additional, fewer, or different operations (e.g., steps, sub steps, etc.) than what is described herein may be performed depending on the particular arrangement. In some embodiments, some, or all operations of method 500 may be performed by one or more processors executing on one or more computing devices, systems, or servers. In various embodiments, each operation may be re-ordered, added, removed, or repeated.

At block 510, the one or more processors (e.g., system processor 110, token processor 130) may receive a loan request corresponding to a downpayment loan or collateral, in response to determining the tokenized product (via the choice interface 190 and the collateral interface 160). The loan request may be received from a user device (e.g., the client system 103, the third-party device, another system or device connected to network 101, etc.). The loan request can include information such as, but not limited to, an first funds account (e.g., a cash account, a digital cash account, etc.) associated with the user device, a receiving funds account associated with the one or more processors, asset information (e.g., fund currency, fund amount, etc.), images and videos of the asset, asset identifier, user information associated with the user address (e.g., blockchain address, wallet address, public and private key pair, public key, private key, account information, location information, exchange history), and so on. The loan request can include a metadata object to identify various information about the loan request, The metadata object can include, a sender of the loan request, a digital wallet corresponding to the sender, a requested number of tokens, or attributes to verify an intended customer segment. The sender can be a user of a client device 103 with the digital wallet corresponding to a funds account. The digital wallet can include transactions (e.g., credit cards, debit cards, coupons, gift cards, vouchers, etc.) and currency corresponding to the funds account.

At block 520, the one or more processors (e.g., token processor 310 using a token generator can generate a loan token by tokenizing the downpayment loan or collateral. The loan token may include a link to a loan metadata object that includes metadata of the loan and one or more outputting attributes for outputting funds associated with the loan from the funds account associated with the user device to an entity funds account associated with the data processing system 102 (e.g., the one or more processors, etc.). The one or more outputting attributes may also related to outputting assets (e.g., digital assets, physical assets, etc.) associated with the loan as collateral, for example, from the funds account, a digital address, a physical address, etc. associated with the user device to the entity funds account, an entity digital address (e.g., a first digital wallet, etc.), an entity physical address, etc. associated with the data processing system 102 (e.g., the one or more processors, etc.). The entity and the data processing system 102 may have access (e.g., temporary access, permanent access, etc.) to the funds account, the digital address, and the physical address. The loan metadata object may be encapsulated within a control structure (e.g., smart contract control structure 210) that restricts transfer of the funds and/or assets from the funds account, the digital address, the physical address, etc. to the entity funds account, the entity digital address, the entity physical address, etc.

At block 530, the one or more processors can generate interest on a tokenized product (e.g. choice restricted tokens) based on the loan token. The tokenized product may be associated with first tokens corresponding to the first funds account. The loan token may correspond to a payment schedule. The payment schedule may include guidelines for a payment amount and a payment due date. The payment schedule may further include guidelines for late payment fees that would be triggered and added to a total payment amount in case the payment amount is not paid, partly paid, and/or fully paid by the payment due date. The loan token may correspond to an interest rate associated with the payment schedule. The payment schedule may include guidelines to incorporate the interest rate to an unpaid payment amount, and/or partly paid by the payment due date. The interest on the unpaid payment and/or the partly paid amount can generate in a time period (e.g., hourly, daily, weekly, bi-weekly, semi-monthly, monthly, etc.) specified by a condition for the tokenized product, made by the depositor.

At block 540, the one or more processors (e.g., dynamic token collateral processor 316) may generate a new loan token based on the interest on the tokenized product and the loan token. The new loan token can have characteristics similar to the loan token. The new loan token can include a metadata object similar to the metadata object of the loan token and can include the interest on the unpaid payment and/or partly paid amount. The new loan token can include a loan amount associated with the loan token and the interest on the loan amount associated with the loan token. In some cases, there is no interest generated from the loan amount in the loan token. Thus, the loan token can be the same as the new loan token.

At block 550, the one or more processors (e.g., cold storage processor 180) may burn the loan token. Burning the loan token may include transmitting the loan token to the un-spendable address (e.g., cold storage ledger 182), where no user and/or device has access to the private key of that particular un-spendable address. Accordingly, the loan token would be un-spendable and un-exchangeable. Burning the loan token can include transmitting the loan token to a burning digital wallet. The burning digital wallet can only receive tokens which are used during a transaction (e.g., exchange, withdrawal, etc.) The metadata object of the loan token may include a pointer to the address of the burning digital wallet. In this case, the loan token would be un-spendable and un-exchangeable.

At step 560, the one or more processors (e.g., token transfer processor 330, wallet transfer processor 340) can transmit the new loan token to the first digital wallet (e.g., reception digital wallet). The new loan token can replace the burned loan token in the block on the blockchain corresponding to the first digital wallet. The metadata object (e.g., metadata object 224) associated with the burned loan token, can be copied into the metadata object of the new loan token to preserve the intended customer segment and condition of the tokenized product associated with the first digital wallet. The first digital wallet may be associated with the one or more processors such that the digital wallet is accessible by the one or more processors. The first digital wallet can include the loan token with information corresponding a second digital wallet (e.g., transmitted digital wallet). The second digital wallet can include information corresponding to the borrower and can include a tokenized product (e.g., assets, funds). The new loan token may include a digital address (e.g., address of the second digital wallet, address of the first digital wallet), biometric data, fingerprint data, GPS location, among others to verify the loan token is requested from the first digital wallet and there is an agreement with the depositor of the first digital wallet and the borrower of the second digital wallet.

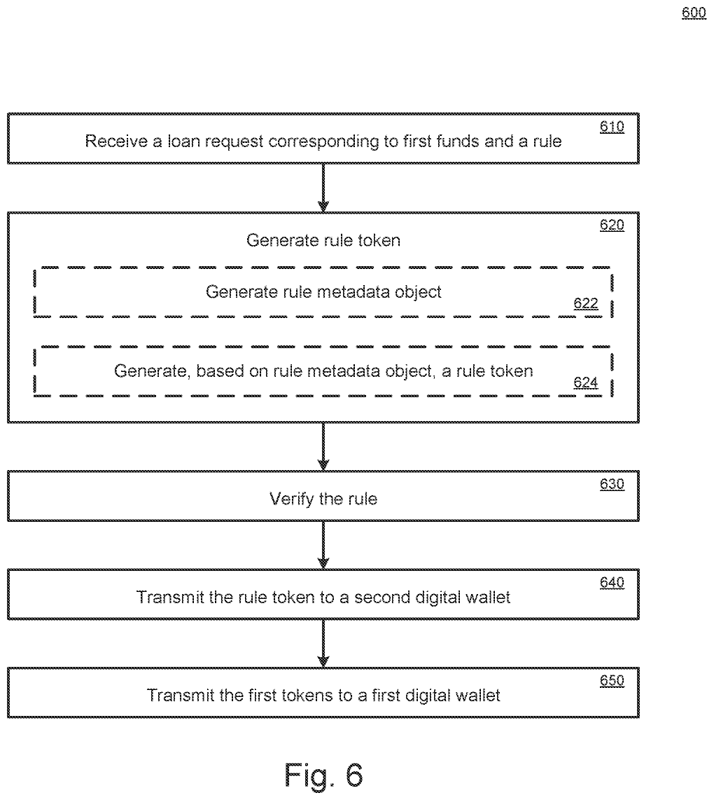

Referring now to FIG. 6, a flowchart for a method 600 to facilitate asset exchanges utilizing tokens (e.g., fungible tokens, semi-fungible tokens, NFT, etc.) in accordance with present implementations. At least one of the example systems 100 and 200 or the example structure 300 can perform method 600 according to present implementations. It is to be appreciated that additional, fewer, or different operations (e.g., steps, sub steps, etc.) than what is described herein may be performed depending on the particular arrangement. In some embodiments, some, or all operations of method 600 may be performed by one or more processors executing on one or more computing devices, systems, or servers. In various embodiments, each operation may be re-ordered, added, removed, or repeated.

At block 610, the one or more processors may receive, from a first computing system, a loan request corresponding to a first funds and a rule. The loan request can be received from the first computing system (e.g., the client system 103, the third-party device, another system or device connected to network 101, etc.). The loan request can include information such as, but not limited to, the origin funds account associated with the first computing system, a receiving funds account associated with the one or more processors, asset information, images and videos of the asset, asset identifier, user information, and so on. Receiving may include the one or more processors receiving a confirmation of, or confirming, a transfer of the first funds from the origin funds account to the receiving funds account and a transfer of the agreement from an origin digital or physical address to a receiving digital or physical address. The rule can include terms (e.g., terms of a contract, intendent customer segment, condition for a tokenized product, collateral specification, legal document, etc.) to regulate the use of the first funds by a financial institution.

At block 620, in response to receiving the loan request, generate first tokens by tokenizing the first funds (e.g., wallet toke processor 312 and generate a rule token by tokenizing the rule (e.g., rule processor 350 using the token generator 360). Tokenizing the first funds includes generating a funds metadata object that includes metadata of the first funds, and generating, based on the funds metadata object, the first tokens that include a link to the funds metadata object. At sub step 622, the one or more processors can generate a rule token (e.g., choice restricted token 220) by tokenizing the rule. Tokenizing the rule can include generating a rule metadata object that includes metadata of the rule, and generating, based on the rule metadata object, the rule token that includes a link to the rule metadata object. The metadata object of the rule may include a text document associated with the rule (e.g., a text document of the rule, text signatures of an owner specifying the rule, etc.) a digital image associated with rule (e.g., an image of the rule), or the like.

At step 630, the one or more processors (e.g., token authenticator processor 308) can verify, by a digital signature of a user device, the rule between an owner a first digital wallet (e.g., reception digital wallet) and an owner of a second digital wallet (e.g., transmission digital wallet). The digital signature can be one of a simple electronic signature (e.g., keyboard signature using initials or name of the owner, image of a signature, etc.), an advanced electronic signature (e.g., fingerprint, biometric scan, password, access code, facial recognition, private-public key pair, etc.), a qualified electronic signature (e.g., regulator approved qualified trust service provider, cryptography, third party signer on a secure server, etc.). The owner of the second digital wallet can be specified in a tokenized product corresponding to the first funds as an intended customer segment.

At block 640, the one or more processors (e.g., token transfer processor 330, wallet transfer processor 340) may transmit the rule token to the second digital wallet. The one or more processors can access the owner of the second digital wallet by accessing the metadata object associated with the rule token. The metadata object may include a pointer to the address of the second digital wallet. The pointer be used to access any data stored within the metadata object and change object fields associated with the address to correspond to an exchange (e.g., withdrawal or deposit). The one or more processors may detect an indication by a matching mechanism for the owner of the second digital wallet. The indication can be a notification, a flag, a status, or included in an object filed of the metadata object of the rule token.

The matching mechanism can send the indication over a network 101 by a data processing system 102 as a data packet, a message, or a notification to the client device 103 corresponding to the owner of the first digital wallet. The matching mechanism can be a method executable by the one or more processors to determine, by the first computing system (e.g., data processing system 102) associated with the first digital wallet, a location of the owner of the second digital wallet. The data processing system may determine the location using at least one of Global Positioning system (GPS), Wi-Fi positioning, Cell Tower Triangulation, Bluetooth beacons, Radio-Frequency Identification (RFID), Geofencing, Magnetic Positioning, IP Geolocation, Near Field Communication (NFC), among others. The one or more processors may determine that the location is within an area corresponding to a condition embedded in the first tokens. The area can a specific geographic region defined based on boundaries and extent. The area can describe a physical geography (e.g., rivers, mountains, forests, ecosystems), cultural area (e.g., religion, customs, language, traditions), time zones, or a military area, among others. The one or more processors an define the area using connection points between the client device 103 associated with the owner of the first digital wallet and the client device 103 associated with the owner of the second digital wallet 103. The connection points can include geographic coordinates (e.g., longitude and latitude) or cell tower locations.

For example, the condition embedded in the first tokens may require the location of the owner of the second digital wallet to be located within the United States before a transmission of the first tokens can occur. In another example, the embedded in the first tokens may specify that the owner of the second digital wallet to be of a specific culture. In another example, the embedded in the first tokens may require the owner of the second digital wallet to be located within a 5-mile radius of the owner of the first digital wallet. The first computing system can generate the indication based on the verification of the area corresponding to the condition.

At block 640, the one or more processors can transmit the rule token to the second digital wallet. The rule token can include one or more rules associated with the first tokens at the second digital wallet. The rule token can include an agreement metadata object that includes metadata of an agreement, and generating, based on the agreement metadata object, the rule token that includes a link to the agreement metadata object. The metadata object of the agreement may include a text document associated with the agreement (e.g., a text document of the agreement, text signatures of the parties bounded by the agreement, time at which the agreement was signed by each party or all parties, etc.), a digital image associated with agreement (e.g., an image of the agreement, an image of the parties bounded by the agreement accepting the agreement (e.g., signing, shaking hands, etc.), etc.), a video associated with the agreement (e.g., a video of the agreement, a video of the assets associated with the agreement, a video of the parties bounded by the agreement accepting the agreement, etc.), or the like. The rule token can include an object field for the digital signature upon, the signature of the agreement.

At block 650, the one or more processors can transmit the first tokens to the first digital wallet. Prior to transmitting the first tokens, the one or more processors may receive the digital signature from the owner of the second digital wallet. The rule token can be transmitted to the first digital wallet to verify the digital signature. The verification can require the one or more processors to access the object field for the digital signature and the agreement metadata object. For example, an owner of a second digital wallet can send a loan request to an owner of the first digital wallet. A computing system associated with the first digital wallet can transmit a rule token to the second digital wallet, the rule token including an object filed for a digital signature and an agreement. The owner of the second digital wallet may access the object field and store a digital signature at the address of the object field in the rule token. A computing system associated with the second digital wallet can transmit the rule token to the computing system associated with the first digital wallet. The computing system associated with the first digital wallet can verify the digital signature in the object field of the rule token and transmit the first tokens to the second digital wallet.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed:

1. A system comprising a memory and one or more processors configured to:
receive, from a first computing system of a depositor over a network, a deposit request corresponding to a first funds;
in response to receiving a deposit request, generate first tokens by tokenizing the first funds;
receive, from the first computing system, a message indicating at least one of a type or a condition of tokenized products to which the first token is applied;
generate one or more smart contracts for applying the first tokens to the at least one of the type or the condition of the tokenized product;
identify a tokenized product of a user with the type of the tokenized products, the tokenized product comprises at least one attribute that fulfills the condition; and
execute the one or more smart contracts to apply the first tokens to the tokenized product of the user.

2. The system of claim 1, wherein tokenizing the first funds comprises:
generate a metadata object comprising metadata of the first funds, the metadata indicating the at least one of the type or the condition of the tokenized products to which the first token is applied; and
embed the metadata object to the first token.

3. The system of claim 1, wherein the one or more processors are further configured to:
in response to determining a tokenized product, receive a loan request corresponding to a downpayment loan or collateral;
in response to receiving the loan request, generate a loan token by tokenizing the downpayment loan or collateral; and
transmit the loan token to a digital wallet.

4. The system of claim 3, wherein generating a loan token by tokenizing the downpayment loan or collateral comprises:
generate interest on the tokenized product based on the loan token;
generate a new loan token based on the interest on the tokenized product and the loan token;
burn the loan token; and
store the new loan token as the loan token.

5. The system of claim 1, wherein generating first tokens comprises:
use a private key to create the first tokens;
use a public key of depositor to associate the depositor to the first tokens, the depositor is identified by the public; and
mint the first tokens by using the private key by executing one or more smart contracts.

6. The system of claim 1, wherein receiving from the first computing system, the message indicating at least one of the type or the condition of tokenized products to which the first token is applied comprises:
select, from the first computing system of the depositor over the network, an intended customer segment; and
embed the intended customer segment as a condition in the first tokens, wherein the first token has an object field for the intended customer segment.

7. The system of claim 6, wherein selecting, from the first computing system of the depositor over the network, an intended customer segment comprises receive, by the first computing system, a determination by the depositor to specify the use of the first tokens.

8. The system of claim 1, wherein the type of a tokenized product comprises an identification for a group of products or services corresponding the providing funds or tokens to a user.

9. The system of claim 1, wherein executing the one or more smart contracts to apply the first tokens to the tokenized product of the user comprises executing a first contract when a borrow matches the intended customer segment.

10. The system of claim 9, wherein the borrow is linked to a borrow metadata object, the borrow metadata object includes a borrower corresponding to a second digital wallet and the intended customer segment.

11. A system comprising a data processing system, the data processing system comprising memory and one or more processors configured to:
receive, from a first computing system, a loan request corresponding to first funds and a rule;
in response to receiving the loan request, generate first tokens by tokenizing the first funds and generate a rule token by tokenizing the rule;
transmit the rule token to a second digital wallet associated with the first computing system; and
transmit the first tokens to a first digital wallet.

12. The system of claim 11, wherein, generating first tokens by tokenizing the first funds and generating a rule token by tokenizing the rule comprises verify, by a digital signature of a user device, the rule between an owner the first digital wallet and an owner of the second digital wallet.

13. The system of claim 11, wherein transmitting the rule token to a second digital wallet associated with the first computing system comprises detect, an indication by a matching mechanism for the owner of the second digital wallet.

14. The system of claim 13, wherein the matching mechanism comprises determine, by the first computing system, a location of the owner of the first digital wallet;
determine that the location is within an area corresponding to a condition embedded in the first tokens; and
generate, by the first computing system, the indication based on the area corresponding to the condition.

15. The system of claim 11, wherein the one or more processors are further configured to, in response to receiving a conversion request associated with the first tokens, convert the first tokens into fiat funds and transfer the fiat funds into a funds account associated with the one or more processors.

16. The system of claim 11, wherein tokenizing the first funds comprises:
generate a funds metadata object comprising metadata of the first funds, and
generate, based on the funds metadata object, the first tokens comprising a link to the funds metadata object; and
tokenizing the rule comprises:
generate a rule metadata object comprising metadata of the rule, and
generate, based on the rule metadata object, the rule token comprising a link to the rule metadata object.

17. The system of claim 11, wherein the one or more processors are further configured to:
receive a loan request corresponding to a downpayment loan or collateral;
in response to receiving the loan request, generate a loan token by tokenizing the downpayment loan or collateral; and
transfer the loan token to the first digital wallet.

18. A method executable by a system including memory and one or more processors comprises:
receiving, by the one or more processors from a first computing system of a depositor over a network, a deposit request corresponding to a first funds;
in response to receiving a deposit request, generating, by the one or more processors, first tokens by tokenizing the first funds;
receiving, by the one or more processors from the first computing system, a message indicating at least one of a type or a condition of tokenized products to which the first token is applied;
generating, by the one or more processors, one or more smart contracts for applying the first tokens to the at least one of the type or the condition of the tokenized product;
identifying, by the one or more processors, a tokenized product of a user with the type of the tokenized products, the tokenized product comprises at least one attribute that fulfills the condition; and
executing, by the one or more processors the one or more smart contracts to apply the first tokens to the tokenized product of the user.

19. The method of claim 1, wherein tokenizing the first funds comprises:
generating, by the one or more processors, a metadata object comprising metadata of the first funds, the metadata indicating the at least one of the type or the condition of the tokenized products to which the first token is applied;
generating, by the one or more processors, the first token by embedding the metadata object to the first token.

20. The method of claim 1, further comprising:
in response to determining a tokenized product, receiving, by the one or more processors, a loan request corresponding to a downpayment loan or collateral;
in response to receiving the loan request, generating, by the one or more processors, a loan token by tokenizing the downpayment loan or collateral; and
transmitting, by the one or more processors, the loan token to a digital wallet.
